(19) United States
(12) Patent Application Publication
(10) Pub. No.: US 2005/0178276 A1
(43) Pub. Date: Aug. 18, 2005

(54) Equalizing Tray

(75) Inventors: John Flodin, Moses Lake, WA (US); James Flodin, Moses Lake, WA (US); William Flodin, Moses Lake, WA (US)

Correspondence Address: DYKAS, SHAVER & NIPPER, LLP, P.O. BOX 877, 802 WEST BANNOCK STREET, SUITE 405, BOISE, ID, 83701, US

(73) Assignee: Flodin, Inc., Moses Lake, WA (US)

(21) Appl. No.: 11/028,390

(22) Filed: Jan. 3, 2005

Related U.S. Application Data
(60) Provisional application No. 60/533,903, filed on Jan. 2, 2004.

(51) Int. Cl. A47J 29/02

(52) U.S. Cl. 99/448

(57) ABSTRACT

The invention is an equalizing tray for evenly distributing food pieces in a food transport line, such as before a dewatering step and before a frying step. The even distribution of food pieces is accomplished by adjusting the shape of a tray bottom through raising or lowering the left or right tray side, by raising or lowering the tray center, and by tilting the entire tray. By changing the shape of the tray bottom, the depth of the liquid medium in which food pieces are transported is changed, resulting in even distribution of food pieces.

### PRIORITY

This application claims the priority date of the provisional application entitled Equalizing Tray filed by Flodin, et al. on Jan. 2, 2004 with application Ser. No. 60/533,903.

### BACKGROUND OF THE INVENTION

1. Field of the Invention

The present invention generally relates to food transport lines, and more particularly relates to food processing transport that spreads or equalizes food product in a liquid medium.

2. Background Information

The process of making many foods, including potato chips, involves cutting the potatoes or other food into pieces and floating them in a water medium to a fryer, or other processing device. The following description will focus on potato chips, but it is to be understood that the invention is equally useful to other food processing applications and products.

It is important that the potato chips emerge from the fryer with uniform cooking on every potato chip. If some are uncooked, while others are overcooked, the resulting potato chips are of a lower quality. A problem in making potato chips is to have an even and uniform flow of chips enter the fryer. The more uniform the flow of potato chips into the fryer, the more uniformly they will be cooked, and a higher quality product will result. In every food transport system there are certain flow characteristics that can cause food pieces which are suspended in a liquid medium, to be dispersed in uneven distributions.

For instance, the turns and drops found in a food transport system might result in more of the potato pieces being in the middle of the flow, or to the left or right side, or with a heavier concentration of food pieces along the sides and less in the middle. For most of the transport distance of the food pieces, this is not important. It becomes important when the potato pieces are separated from the water and then dropped into the fryer. When they enter the fryer, they need to be evenly distributed across the entrance to the fryer so that they receive a uniform cooking time and each piece is cooked to the right amount, and is neither over nor under cooked.

What is needed to achieve this is an equalizing tray that is placed as a part of the food transport line. The equalizing tray should be able to cause the distribution of food pieces in a liquid medium to be spread out evenly, so that when it exits the equalizing tray, the food pieces are evenly distributed as it enters the frying portion or other operation.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

These and other objects are accomplished by the product equalizing tray of the invention. The product equalizing tray of the invention is to be used in a food transport line for controlling the distribution of food pieces suspended in a liquid medium. The product equalizing tray includes a tray body that is installed as a component of the food transport line. If the food transport line is generally “U” shaped in cross-section, the tray body could also be U-shaped and form a section of the food transport line. If the food transport line is generally rectangular or square in cross-section, the tray body could also be rectangular or squared in cross-section, and form one unit of the food transport line. The tray body is configured for unrestricted flow of a liquid medium, typically water, and suspended food particles. The food particles can be pieces of cut vegetables, such as french fries, potato chips, diced vegetables, carrot slices or other vegetable pieces. The product equalizing tray is typically used in conjunction with a food processing component, such as a fryer or cooker, in which an equal distribution of food products entering the cooker or fryer is desirable. The product equalizing tray of the invention can also be used with other food processing operations in which an even distribution of products is desirable, such as a device for applying a sprayed on additive, for heating using microwaves, radiant heat, or hot air, but is particularly useful when used in cookers or deep fat fryers.

The tray body is composed of a tray bottom, a left side and a right side. The tray bottom has an entry edge and an exit edge. As the food product crosses over the entry edge, it may be unevenly distributed, but the purpose of the equalizing tray is for the product to be evenly distributed as it passes over the exit edge. Typically, after the product equalizing tray, there will be a dewatering step, so that the distribution of the food pieces is stabilized before entering into the next step of the food processing operation.

In one embodiment of the invention, the product equalizing tray includes a tray positioner or pivot structure, which has the function of tilting the tray body and especially the tray bottom at an angle selected to achieve distribution of food pieces over the tray bottom at the exit edge. By tilting the tray bottom, the depth and flow of the water with the suspended food pieces is adjusted to cause an even distribution at the exit edge of the tray.

Another embodiment of the product equalizing tray utilizes a side height adjuster, which raises and lowers at least one side of the tray to help adjust the flow and depth of the transport media and the suspended food pieces by changing the shape of the tray bottom. This configuration of the device also includes a tray center height adjuster for changing the level of the tray center in relation to the tray sides, or for fixing the tray center position. The interaction between the side height adjuster and the tray center height adjuster changes the shape of the tray bottom, which changes the depth of the medium in order to achieve an equal distribution of the food pieces as the liquid and food pieces exit the equalizing tray.

Another embodiment of the invention is configured as described above, but includes a side height adjuster for both the left and the right sides. In this version, the left side can be raised or lowered, the right side can be raised or lowered, and the center of the tray is attached to a height adjuster which can raise or lower the center of the tray, causing it to be convex, concave or level. The center tray adjuster can also be configured to simply anchor the center of the tray, without height adjustment.

The adjustments described above can be set in several different ways. The characteristics of a particular system may be observed and analyzed, and the shape of the equalizing tray adjusted and locked in place by use of the side height adjusters and the tray center height adjuster. Another way that the equalizing tray can operate is in conjunction with a sensor that determines the distribution of food pieces, and uses automated controls that adjust the left side and right side, and tray center height adjuster to automatically adjust the shape of the tray bottom for even distribution of food pieces. This type of adjustment can be made on a continual and automatic basis.

The side height adjusters can be a mechanical lever that is controlled manually and can be locked into place at a selected position. The side height adjusters can also be servo motors, which are attached to the tray sides, and which can move the left or right tray sides up or down according to the needs of the system. The left and right tray sides can be locked in place with a position lock. The entry side of the tray can be a flat side that interconnects with the upstream transport line section. The entry side of the tray can also be an edge adjacent to an entry slot in which the liquid and food products enter from below the equalizing tray and flow through the entry slot over the entry edge and through the equalizing tray. The system can also be configured so that the equalizing tray has an entry end wall over which water and food pieces flow into the equalizing tray.

In one configuration of the equalizing tray, the center height adjuster can be a mechanical connection that is attached to the under side of the tray center. This mechanical connection can anchor the tray center in place. As such, when the left and right hand sides are raised and lowered, the shape of the tray bottom changes between flat, convex, and concave. Also, the shape of the tray bottom can be made asymmetrical so that one side is higher than another. Another configuration of the device is configured so that the center height adjuster is attached to the underside of the tray center, and is configured to be adjusted up and down, either manually or automatically based on input from a sensor or by adjustment made by a user.

Another configuration of the equalizing tray uses attachment points. In various alternative configurations, the exit edge may be anchored in one or more attachment points. The entry edge can also be anchored at one or more attachment points.

The purpose of the foregoing abstract is to enable the United States Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a perspective view of the equalizing tray of the invention.

FIG. 2 is a top view of the equalizing tray of the invention.

FIG. 3 is a side view of an adjustment handle.

FIG. 4A is a side view from position B of FIG. 2, showing the pivot handle in maximum upward adjustment.

FIG. 4B is a side view from position B of FIG. 2, showing the pivot handle in maximum downward adjustment.

FIG. 5A is a side view from position A of FIG. 2, showing the side height handle in maximum upward adjustment.

FIG. 5B is a side view from position A of FIG. 2, showing the side height handle in maximum downward adjustment.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

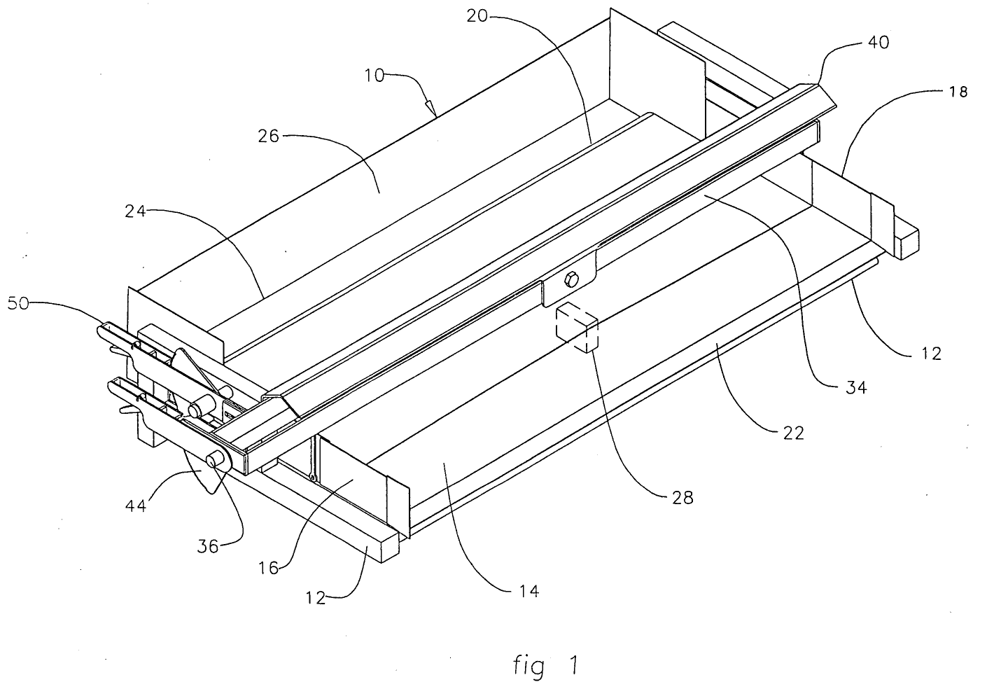

A preferred embodiment of the invention is shown in FIG. 1. Shown in FIG. 1 is an equalizing tray 10, which includes a tray body 12. The tray body 12 includes tray bottom 14, left tray side 16, and right tray side 18. The tray bottom 14 has an entry edge 20 and an exit edge 22. In this particular configuration, the tray bottom 14 includes an entry slot 24. This is configured so that liquid medium and suspended food pieces (not shown) can enter the tray 12 from below the entry slot 24. Other configurations are possible in which the liquid medium and suspended food pieces enter the tray body from above, in a waterfall type entry, or which enter straight into the tray body from the adjacent food transport line. Because this configuration has the liquid medium entering from below through the entry slot, it includes a rear wall 26. A rear wall 26 might not be present if the liquid medium and suspended food particles enter directly from the adjacent upstream section of food transport line.

Also shown is a tray center height adjuster 28. This is shown as a post that is attached to the underside of the tray body 12. The bottom end of the post is attached solidly to other processing line components. As the left side 16 and the right side 18 raise and lower, the tray center height adjuster 28 anchors the center in one place, causing the tray bottom 22 to change shape. In another preferred embodiment, the tray center height adjuster 28 can be adjusted and may move up and down independently from the movements of the left and right sides. This can be by manual or automatic and continual adjustment.

Also shown is a side height adjustment assembly 54 for raising and lowering the left side in this example. By raising or lowering one side or both side, and by either having the center of the tray bottom stationary or adjusted in height, the shape of the tray bottom 22 changes so that the depth of the liquid medium with suspended food pieces can be controlled to achieve an equal distribution of food pieces.

Typically, the section adjacent to the exit edge 22 will be a dewatering step. After the dewatering step, another food processing step will take the evenly distributed food pieces and apply some food processing step to them. In the preferred embodiment, this is a deep fat fryer, in which potato slices are cooked and made into potato chips. Other steps could include processors for french fries, for spraying on additives, or for exposing to hot air, infrared heat, or microwave processes. This equalizing tray can be used with any process that will benefit from having food pieces evenly distributed across a transport system.

The principle of the equalizing tray can be usefully applied to systems that require a diverse range of sizes. However, one particular application, which will illustrate how this system would work, is for potato chip distribution before frying. In such a system, the tray body 12 is made from a single sheet of metal which is formed into a “U” shape. In one embodiment, this U-shape is approximately 60 inches wide from the left side to the right side, and 20 inches long from the exit edge 22 to the entry edge 20. These dimensions would be adjusted depending on the volume and flow characteristics of the systems for which it would be installed in. The left tray side 16 and the right tray side 18 are approximately 3 inches high. In this embodiment, the tray body is made of stainless steel. Obviously, other dimensions and materials might be suitable for building the equalizing tray of the invention for a particular installation.

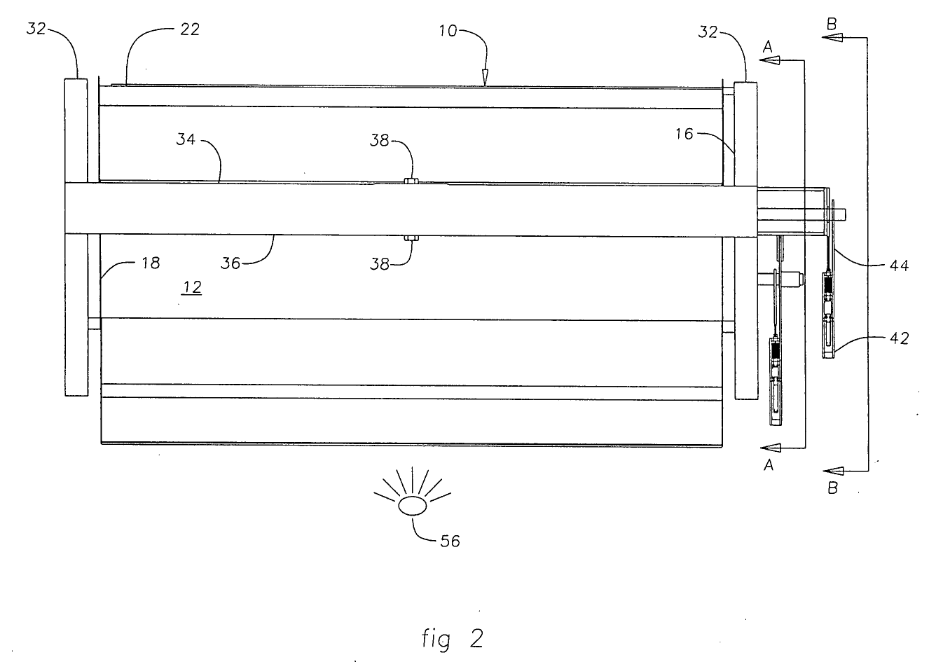

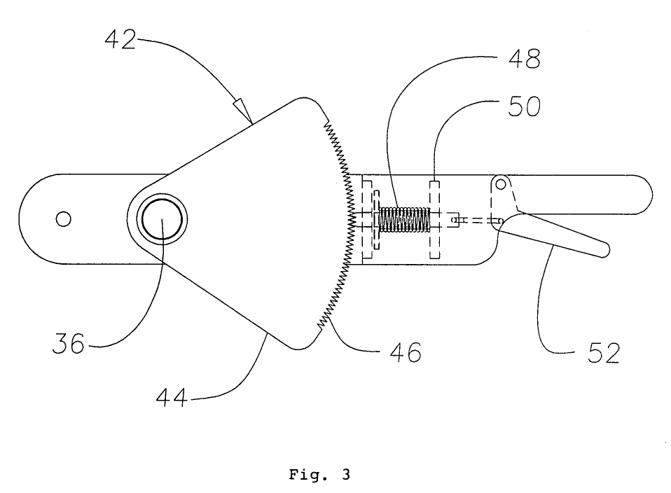

FIG. 2 shows a top view of the equalizing tray body 12. Shown is a frame 32 which provides support to the equalizing tray 10. The equalizing tray 10 includes a tray body 12, a tray left side 16, a tray right side 18, an entry edge 20 and an exit edge 22. Shown above the tray body 12 is a pivot structure 34. The pivot structure 34 comprises two parallel bars, which are spaced on either side of a pivot rod 36. At the center of the pivot structure 34 is a pair of pivots 38. The entire equalizing tray body 12 can be adjusted to rotate around the pivots 38. The pivot structure 34 is typically covered with a pivot structure cover 40, which is better shown in FIG. 1. Adjacent the left tray side 16 is a tray pivot handle assembly 42. The tray pivot handle assembly 42 includes an adjustment plate 44. The tray pivot handle assembly 42 is better shown in FIG. 3. The adjustment plate 44 includes a number of notches 46 into which a position selecting tooth 48 fits. The position selection tooth 48 is attached to the inside of a handle 50, and attached at one end to a release lever 52. When the release lever 52 is activated, the position selection tooth 48 is withdrawn from contact with the notch 46, and the handle 50 may be moved up or down to a new position. The tray pivot handle assembly 42 pivots around the pivot rod 36. As the handle 50 is moved up or down, the tray body 12 pivots to the right or left around the pivots 38 in the center of the pivot structure 34.

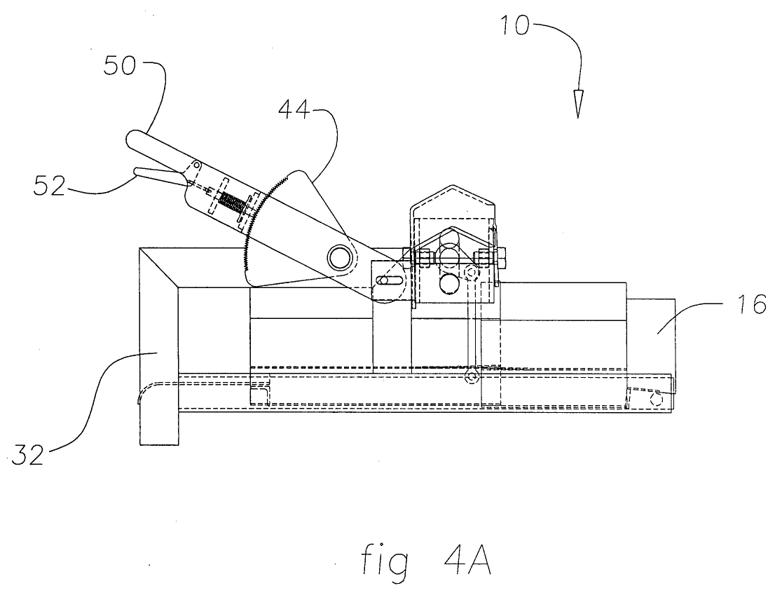

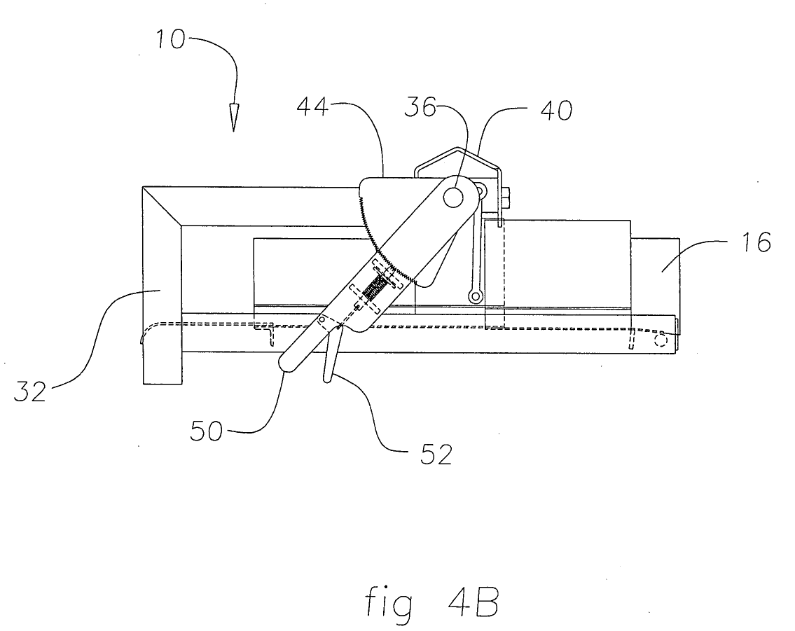

FIGS. 4A and 4B show the equalizing tray 10, with the handle 50 of the tray pivot handle assembly 42 in an up and a down position, showing the corresponding tilt of the tray body 12. This view is of the equalizing tray from cut line B in FIG. 2.

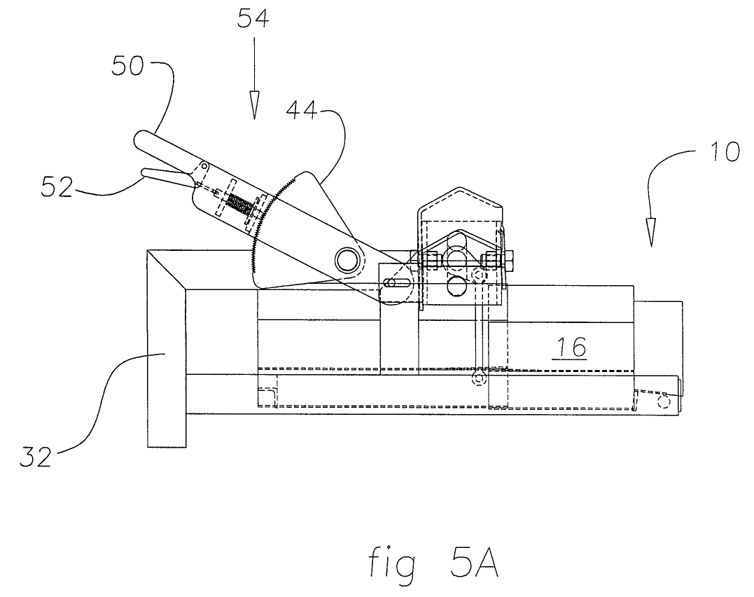

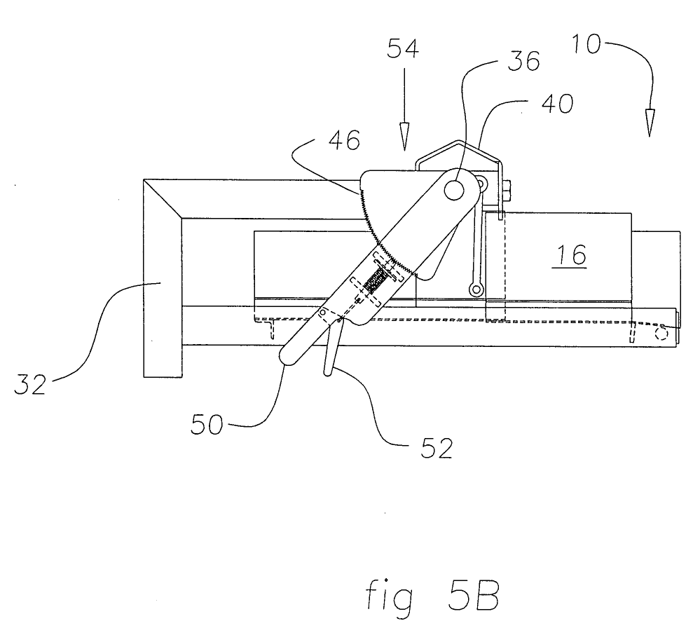

Also included in the equalizing tray 10 is a left side height adjustment handle assembly 54. The left side height adjustment assembly 54 is shown in FIGS. 5A and 5B, and is the view from arrows A in FIG. 2. The left side height adjustment assembly 54 includes similar parts as are contained in the tray pivot handle assembly 42, including an adjustment plate 44, a handle 50 and a release lever 52. It also includes notches 46 and position selection tooth 48, as in FIG. 3, but which is not shown in FIGS. 5A and 5B. The left side adjustment handle 54 raises and lowers the left side 16 of the tray body 12 in relation to the right tray side 18 (not shown in FIGS. 5A and 5B). As the handle 50 is raised, the left tray side 16 is lowered by means of a mechanical linkage to the pivot structure. As the handle 50 is lowered, as shown in FIG. 5B, the left tray side 16 is raised by means of a mechanical linkage to the pivot structure.

The side height adjustment, in order to change the shape of the tray bottom 14, could also be automated, using a system for sensing the distribution of food pieces as it enters the tray and adjusting the tray to achieve the desired tray bottom shape for the best distribution. A sensor 56 would determine the entering and/or exiting distribution of food pieces in the liquid medium, and adjust the tray bottom shape to achieve optimum distribution. The sensor could be located before or after the dewatering section, before the equalizing tray, after the fryer, or in other places in the system that are advantageous.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. A product equalizing tray for use in a food transport line for controlling the distribution of food pieces suspended in a liquid medium, comprising:
a tray body for installation in and operational connection to said food transport line, and configured for flow of a liquid medium and suspended food pieces therethrough, said tray body having a tray bottom, a left tray side, and right tray side, with said tray bottom having an entry edge and an exit edge;
a tray positioner for tilting said tray body at an angle selected to achieve even distribution of food pieces over the tray bottom at said exit edge.

2. An equalizing tray for use in a food transport line for controlling the distribution of food pieces suspended in a liquid medium comprising:
a tray body for installation in and operational connection to said food transport line, and configured for flow of a liquid medium and suspended food pieces therethrough, said tray body having a tray bottom, a left tray side, and right tray side, with said tray bottom having an entry edge and an exit edge; and
a side height adjuster for raising or lowering at least one side of said tray in relation to the other side of said tray, to achieve equalized food piece distribution over said tray bottom, with said tray bottom attached to said sides, so that when said side is raised or lowered, said tray bottom is also raised or lowered; and
a tray center height adjuster for changing the level of the tray center in relation to the tray sides, with said tray center height adjuster attached to said tray bottom, for movement of said tray bottom in relation to said left and right sides.
wherein said equalizing tray is configured to receive a flow of said liquid medium with suspended food pieces at said entry edge, and adjustment of said left and right sides causes said tray bottom to change position, and thus vary the depth and flow of said liquid medium and food pieces to achieve even distribution of food pieces over the tray bottom at said exit edge.

3. The equalizing tray of claim 2, in which said tray center height adjuster is fixed in position, and changes the height of the tray center by immobilizing the tray center.

4. The equalizing tray of claim 2, in which said tray center height adjuster is variable in position, and changes the height of the tray center by movement of said tray center in relation to said left and right sides.

5. The equalizing tray of claim 2 which further includes a pivot structure for rotation of said tray sides and tray bottom as a unit, so that one side is lowered as the other side is raised, and the tray bottom is tilted.

6. The equalizing tray of claim 5 which further includes one or more pivots around which said equalizing tray rotates.

7. The equalizing tray of claim 6 which further includes an adjustment handle for adjusting the rotation of said equalizing tray about said pivots.

8. The equalizing tray of claim 2 which further includes a side height adjustment handle for raising or lowering a selected side of said equalizing tray.

9. The equalizing tray of claim 8 in which said side height adjustment handle further comprises a position selection tooth which interacts with position notches, for locking said tray side at a selected height.

10. An equalizing tray for use in a food transport line for controlling the distribution of food pieces suspended in a liquid medium comprising:
a tray body for installation in and operational connection to said food transport line, and configured for flow of a liquid medium and suspended food pieces therethrough, said tray body having a tray bottom, a left tray side, and right tray side, with said tray bottom having an entry edge and an exit edge; and
a side height adjuster for raising or lowering at least one side of said tray in relation to the other side of said tray, to achieve equalized food piece distribution over said tray bottom, with said tray bottom attached to said sides, so that when said side is raised or lowered, said tray bottom is also raised or lowered;
a tray center height adjuster for changing the level of the tray center in relation to the tray sides, with said tray center height adjuster attached to said tray bottom, for movement of said tray bottom in relation to said left and right sides; and
a tray pivot structure for rotation of said tray sides and tray bottom as a unit, so that one side is lowered as the other side is raised, and the tray bottom is tilted;
wherein said equalizing tray is configured to receive a flow of said liquid medium with suspended food pieces at said entry edge, and adjustment of said left and right sides causes said tray bottom to change position, and thus vary the depth and flow of said liquid medium and food pieces to achieve even distribution of food pieces over the tray bottom at said exit edge.

11. The equalizing tray of claim 10 which further includes an adjustment handle for adjusting the rotation of said equalizing tray about said pivots.

12. The equalizing tray of claim 11 in which said side height adjustment handle further comprises a position selection tooth which interacts with position notches, for locking said tray side at a selected height.

13. The equalizing tray of claim 10 which further includes a side height adjustment handle for raising or lowering a selected side of said equalizing tray.

14. The equalizing tray of claim 13 in which said side height adjustment handle further comprises a position selection tooth which interacts with position notches, for locking said tray side at a selected height.

15. An equalizing tray for use in a food transport line for controlling the distribution of food pieces suspended in a liquid medium comprising:
a tray body for installation in and operational connection to said food transport line and configured for unrestricted flow of a liquid medium and suspended food pieces therethrough, said tray body having a tray bottom, a left tray side, and right tray side, with said tray bottom having an entry edge and an exit edge; and
a left side height adjuster for raising or lowering said left tray side to achieve equalized food piece distribution over said tray bottom, with said tray bottom attached to said left side, so that when said left side is raised or lowered, said tray bottom is also raised or lowered;
a right side height adjuster for raising or lowering said right tray side of said tray body to achieve equalized food piece distribution over said tray bottom in conjunction with said left side height adjuster, with said tray bottom attached to said right side, so that when said right side is raised or lowered, said tray bottom is also raised or lowered; and
a tray center height adjuster for changing the level of the tray center in relation to the tray sides;
wherein said equalizing tray is configured to receive a flow of said liquid medium with suspended food pieces at said entry edge, and adjustment of said left and right sides causes said tray bottom to change position, and thus vary the depth and flow of said liquid medium and food pieces to achieve even distribution of food pieces over the tray bottom at said exit edge.

16. The equalizing tray of claim 15 in which said equalizing tray can be configured for continual and automatic adjustment to achieve equal distribution of food pieces.

17. The equalizing tray of claim 15 in which said left side height adjuster is a lever that is controlled manually and moves said left side up or down to a selected height, and said right side height adjuster is a lever which is controlled manually and moves said right side up or down to a selected height.

18. The equalizing tray of claim 15, which further includes a position lock for each height adjuster for locking the left or right side to a selected position.

19. The equalizing tray of claim 15 in which said tray body includes an entry side connected to said left and said right side, with said entry edge being located on a top edge of said entry side, with said equalizing tray configured in said transport line so that said liquid medium and said suspended food pieces enter said equalizing tray over said entry side.

20. The equalizing tray of claim 15 in which said tray center height adjuster is a mechanical connection to an underside of said tray center, so that as said left and right sides are raised and lowered, the tray center remains anchored, thus changing the profile of the tray bottom from flat to convex or concave.

21. The equalizing tray of claim 15 in which said tray bottom is anchored at said exit edge in one or more attachment points.
